(19) United States
(12) Patent Application Publication
(10) Pub. No.: US 2006/0074760 A1
(43) Pub. Date: Apr. 6, 2006

(54) System and method for calling and communication based on search engine

(76) Inventors: Calvin Darrell Helin, Richmond (CA); Song Liang, Vancouver (CA)

Correspondence Address: Calvin Helin, 7131 Marrington Road, Richmond, V7C1V4, CA

(21) Appl. No.: 10/947,012

(22) Filed: Sep. 21, 2004

(51) Int. Cl. G06Q 30/00

(52) U.S. Cl. 705/26

(57) ABSTRACT

A method of calling and setting up communication link from an Internet search engine and searching service. System components include: (a) a database; (b) a search engine; (c) a control server; (d) a client-side component; (e) a web server (hosting a web-site for a business or organization or individual who associates with the search result, the said client-side component also embedded in web pages of the said web-site); (f) a gateway transferring audio data into PSTN; (g) a client software or (h) an interface or (i) a call center or (0) an information appliance (such as an ordinary telephone, PC or PDA, taking/answering the call). Components set up instant online communication based upon the search terms entered into a search engine. Integrates VoIP techniques, search engine, audio CODEC, video CODEC, TCP/IP, database management technology, providing a communicating platform and data communicating services.

### BACKGROUND OF THE INVENTION

The present invention relates to a search engine based calling and communication system, and more particularly, to systems, methods and business models for providing instant communication assistance from a business or organization to a search-engine-user in need of goods and/or services. The invention pertains even more particularly to systems, methods, and methods of doing business for providing communication link over ordinary wired or wireless telephone systems, PC systems, call center system, Personal Data Assistants (PDAs), and other communication and information appliances and devices.

One of the most important uses of the World Wide Web (Internet) is to search out information contained in one or more servers on the Web by search engine. The problem is that the information is often not the information a searcher might desire nor is it in a format that the searcher can utilize. Hence, people still need to “call up” the a business or an organization or an individual associating with the search result to figure out how to do something, find something, some person or some information.

The uniqueness of this invention is that there is currently no tool that allows people to communicate instantly with someone based on their string inquiries entered into a search engine. Before the invention of this system, search engine only provides responses to the request from a searcher. However, this invention not only provides searching results, but also helps to setup instant communication link between users and a business or an organization or an individual associating with the search result. The communication including audio, video, text, and other data transmission.

### BRIEF SUMMARY OF THE INVENTION

The invention provides apparatus, methods, and business models for setting up instant online communication based upon the search terms entered into a search engine. This invention integrates VoIP techniques, search engine, audio CODEC, video CODEC, TCP/IP, database management technology, providing a communicating platform and data communicating services. The said data including audio data, video data, text, picture, file, IVR output etc.

Currently, a search engine search result typically returns a list of Internet addresses in the form of hyperlinks. Beside the hyperlink line, the invention proposes to add a special new icon or web element in other forms—this will appear beside the hyperlink Internet address line, digital IDs and/or phone numbers. By clicking on the icon, users operate/activate a client-side component in the form of small plug-in software that is embedded in search result pages or web pages or browser. When the icon is clicked it allows users to communicate directly with a business or organization or individual associated with the search result. In this communication, search engine users call into a service, a call center or PSTN network which comprises ordinary telephone, PC, PDA, or other information appliance. When a busy signal is reached, users are asked to input their telephone number, name, address and comment. The above information is stored in database for business query. This information can be used for customer marketing and follow up purposes. Internet user can click on the button and follow the instructions to communicate with correspondent by audio, video, picture, file data, IVR data or the combination, or to communicate with information appliance directly.

Who will benefit from this invention? People who are having trouble utilizing their new product purchase, such as a PC or PDA and would like to talk or chat with a business which sells those products, or with someone who has bought the same or similar product earlier and figured out how to use it. Also, someone researching a rare disease and seeking a medical expert might use this invention with life saving results. Or for emotional reasons a user might want to communicate with someone who has had the same experience of going through a layoff or divorce.

Search engine users make requests for information on goods or services or other terms, and search engine provides results to the request in real-time. Currently, a search engine search result typically returns a list of Internet addresses in the form of hyperlinks. Beside the hyperlink line, the invention proposes to add a special new icon or web element in other forms—this will appear beside the hyperlink Internet address line, digital IDs and/or phone numbers. By clicking on the icon, users operate/activate a client-side component in the form of small plug-in software that is embedded in search result pages or web pages or browser. When the icon is clicked it allows users to communicate directly with a business or organization or individual associated with the search result. When a busy signal is reached, users are asked to input their telephone number, name, address, comment and other information. The above information is stored in database for business query and can be used for customer marketing and follow up purposes. Internet user can click on the button and follow the instructions to communicate with correspondent by audio, video, picture, file data, IVR data or the combination, or to communicate with information appliance directly.

The client-side component could be embedded both in the search results coming from a search engine and in web pages hosted by said web server. In this communication, search engine user calls into a call center, a client software or PSTN network comprising information appliance, or combination thereof. The said information appliance includes an ordinary telephone, PC, PDA or others.

The invention provides a search-engine-based calling and communication system, including: (a) a database storing a plurality of data items; (b)a search engine searching the database for particular data items in response to the input command and data; (c) a control server for signaling control, communication management and fee schedule management; (d) a client-side component, embedded in search engine outputs, setting up signaling communication with control server, communicating data to gateway or client software and collecting user's information into the said database, said information including name, telephone number, address and message; (e) a web server hosting a web-site for a business or organization or individual who associates with the search result, the said client-side component also embedded in web pages of the said web-site; (f) a gateway transferring audio data into PSTN; and (g) a client software or (h) an interface or (i) a call center or O)an information appliance, such as an ordinary telephone, PC or PDA, taking/answering the call.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a block diagram showing the structure of the system

FIG. 2 is a block diagram showing the structure of the software platform

FIG. 3 is a block diagram showing functions of the control server of FIG. 2

FIG. 4 is a block diagram showing functions of the client-side component/client of FIG. 2

FIG. 5 is a block diagram showing data communication set up by a client-side component in search engine pages of FIG. 1

FIG. 6 is a block diagram showing data communication set up by a client-side component in web pages of FIG. 1

FIG. 7 is a diagrammatic illustration showing an exemplary search result page with client-side component embedded

FIG. 8 is a diagrammatic illustration showing an exemplary web page with client-side component embedded

FIG. 9 is a flow-chart for the search engine based communication system

FIG. 10 is a flow-chart for setting communication channel of FIG. 9

### DETAILED DESCRIPTION OF THE INVENTION

Reference will now be made in detail to the preferred embodiments of the present invention, examples of which are illustrated in the accompanying drawings.

1. Structure of the System:

The whole system comprises (a) database; (b) search engine; (c) control server; (d) client-side component; (e) web server; (f) gateway; (g) client software; (h) an interface; (i) call center; and (j) an information appliance.

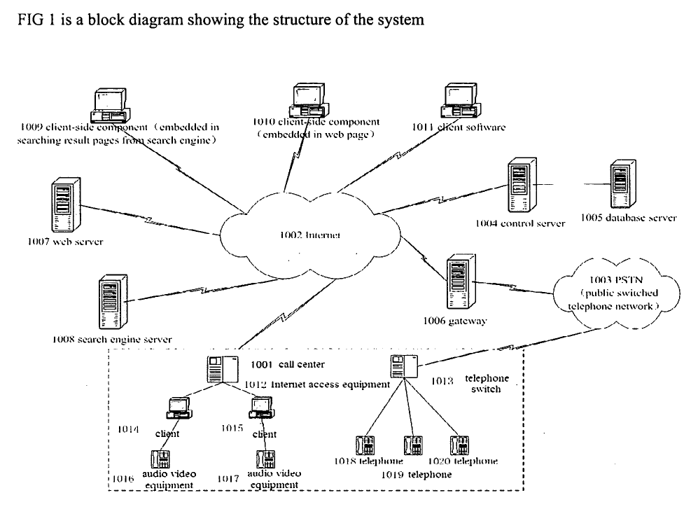

As shown in FIG. 1, call center (1001) comprising Internet access equipment (1012), telephone switch (1013), client software (1014/1015), and telephone (1018, 1019 and 1020). Aforementioned client software (1014 and 1015) supports audio/video equipment (1016/1017). The call center (1001) carries out inter communication in enterprise or communications between/among enterprises. Internet access equipment (1012) connects to the Internet. Telephone switch (1013) connects to PSTN. 1006 is a gateway, performing signaling and data conversion between Internet and PSTN. 1008 is a search engine server for the Internet. 1007 is a web server. 1009 is a client-side component embedded in the search results coming from a search engine and 1010 is a client-side component embedded in a web page, which is hosted by said web server. 1011 is client software connecting to Internet. 1004 is a control server for signaling control, communication management and fee schedule management. 1005 is a database server working together with control server. The constitution of the system is scalable. There is no quantitative limitation for call center (1001), control server (1004), database server (1005), search engine server (1008), client-side component (1009, 1010), gateway (1006) and web server (1007).

2. Structure of Software Platform

The software platform adopts the client/server structure. The server-side software run as independent application or service. The system consists of server-side software on one server or on multi-server in order to balance the load according to the volume of connections to the server. The control server performs signaling control, communications management and fee schedule management. There are two kinds of client software: (a)a client software running independently on the client side; (b)a plug-in software, such as Active X controls, Java applets, dynamic link libraries, .cab files, jar files, or HTML content, running as a component on the client side. For example, an ActiveX control running on container programs, such as web browser, may serves as the client-side component. This ActiveX control is embedded in web pages hosted by said web server or embedded in search result pages coming from a search engine. Through TCP/IP protocol, a communications link is setup between client software/client-side component and server.

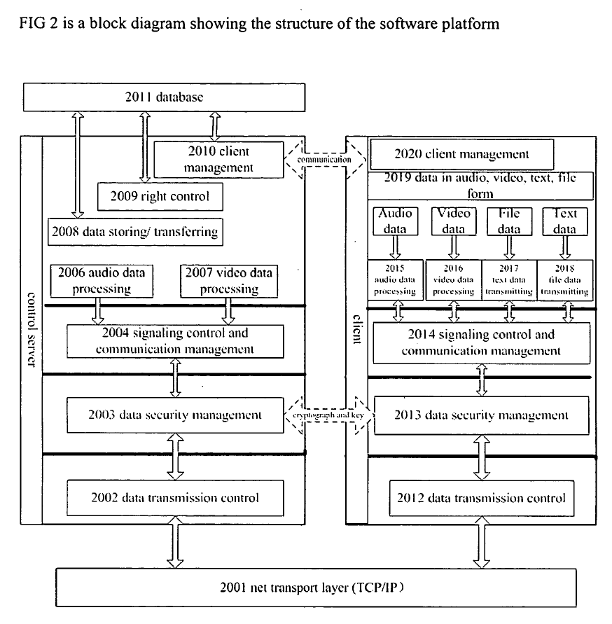

As shown in FIG. 2, the system includes control server, client and database server (2011). Control server adopts a layered structure. The function of control server comprises data transfer control (2002), data security management (2003), and signaling control (2004). The application process layer of control server comprises audio data processing (2006), video data processing (2007), data storing/transferring (2008), access control (2009), user management (2010). Client-side program also adopts a layered structure. Server and client interact through net transport layer using TCP/IP protocol.

3. Function and Realization for Control Server

The main function of control server includes signaling control, user management, access control, data storing/transferring, client management, fee schedule management, gateway control, data security management, and so on. The functions of signaling comprise client calling, searching, link-setup, state control, data exchanging/transferring, firewall surveillance/penetrating, etc. The said function is realized by the SOCKET function of TCP/IP. User management is to control user's related file and data. Each user has at least one unique ID, the ID including digital number, Email address, Internet IP address and character string. Data storing/transferring includes data stream directing and temporary data storing; client management is to perform client version control and update. User management, right control, and data storing/transferring are supported by database. Fee schedule management and gateway control work together to support the connection between Internet and PSTN. Gateway converts signaling of control server into H.323 or into SIP signaling. Data security management supports data encryption and transmission. The encryption comprise RSA, MD5 and DES/3DES.

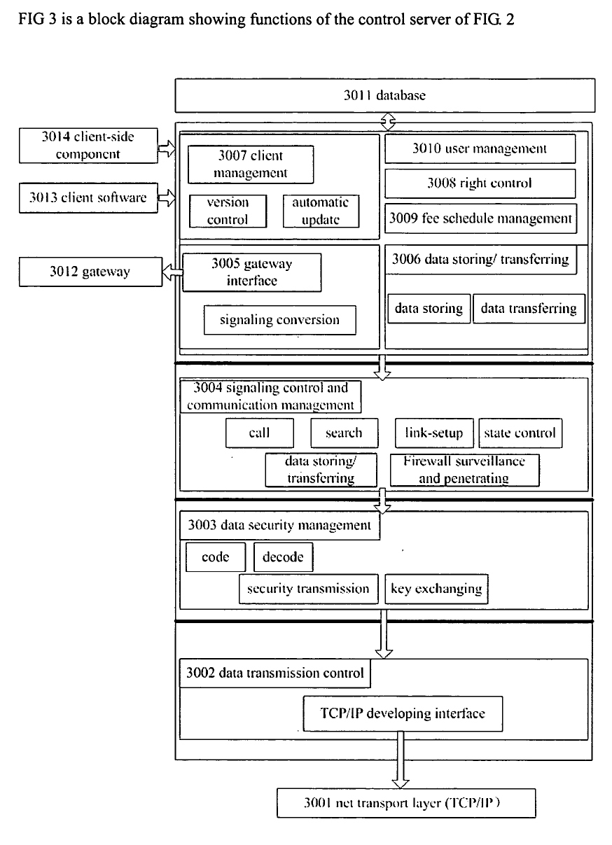

As shown in FIG. 3, control server adopts layered structure. Data transport control layer (3002) performs data transmission through the TCP/IP interface provided by network transport layer (3001). Data security management layer (3003) performs data encryption and transmission through the interface provided by data transport control layer (3002). Signaling control performs signaling and data transmission through the interface provided by data security management layer (3003). Application function layer (including: client management(3007), gateway control(3005), data storing/transferring(3006), user management(3010), right control(3008), fee schedule management(3009) performs function by signaling control and communication management (3004), data security management layer (3003) and data transport control layer (3002), and database provider. Client (3013)/client-side component (3014) setup communication link by application of function layer and control server. Gateway interface (3005) controls the gateway (3015).

4. Interface of Gateway

Interface of gateway supports the connection between Internet and PSTN by converting signaling and data. Interface of gateway supports both H.323 and SIP signaling. Interface of gateway converts signaling, which comes from control server, into H.323 or SIP. With this gateway interface, this whole system supports most popular gateway.

Function and Realization of Client-Side Program

Client-side program includes client software and client-side component. Client-side component can't run independently, but it can be integrated into container-software or vehicle-program or other client software as a part of them. The functions of client includes signaling control, communication management, data transmission control, data security management, audio data processing, video data processing, text message processing, file transmission, message management, automatic update, IVR output and hardware setting etc. Working together with control server, client-side program performs signaling control function, including calling, searching, link-setup, state control, data exchanging and transferring, firewall surveillance and penetrating etc. Data transmission function controls real-time data transmission; bandwidth self-adoption, asynchronous data transmission. Signaling control and data transmission is achieved by TCP/IP protocol. Data security management is responsible for data encryption and transmission. Audio data processing includes real-time audio capture, CODEC, transmission, replay. Video data processing includes real-time video capture, CODEC, transmission, play. Both audio and video CODEC comply with SIP and H.323 protocol. Text message processing completes real-time text data transmission. Both text message processing and file transmission performs in cryptograph. IVR response to audio, video and picture requests. Hardware setting provides option of audio/video devices

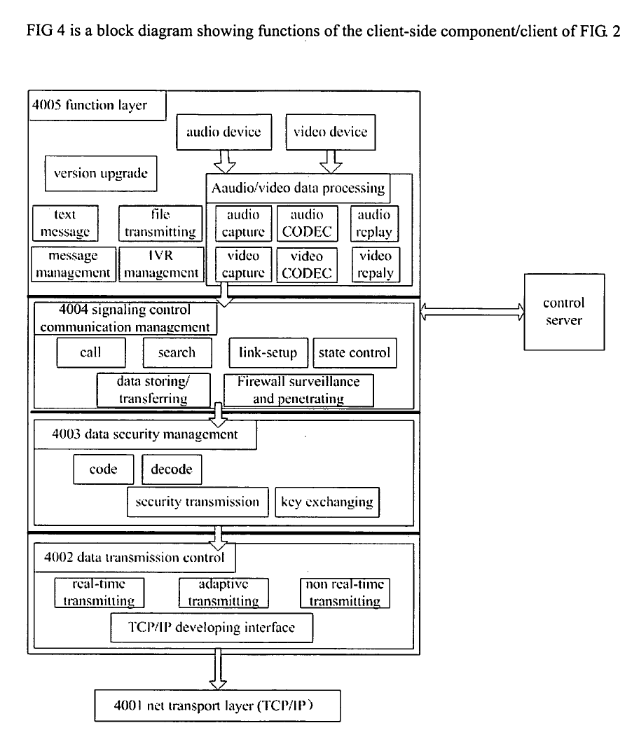

As shown in FIG. 4, client-side program is a layered structure. On client side, data transport layer (4002), data security management (4003) and signaling control function (4004) are correspondent to and those layer and function on the control server. Real-time transmission control, adaptive transmission and non real-time transmission are achieved in client-side data transmission (4002). Application layer (4005) includes auto version update, text message, file transmission, message management, IVR management, and audio and video processing.

6. The Client-Side Component in Internet Search Engine.

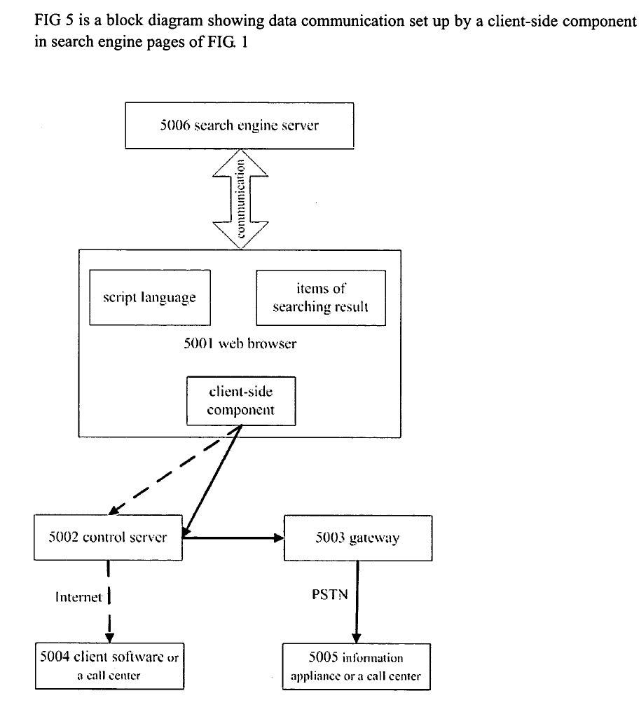

Client-side component runs in container-software or vehicle-program or other client software, such as Internet browser. Users operate client-side component by script language in searching result pages. Before the invention of this system, search engine only provides responses to the request from users. However, this invention not only provides searching results, but also helps to setup instant communication link between users and a business or organization or individual associating with the search result. The communication including audio, video, text, and other data transmission. On one end of the communication, user operates the client-side component to setup a call. On the other end of the communication, people take/answer the call through client software or a call center or an information appliance, such as an ordinary telephone, PC or PDA. As shown in FIG. 5, data communication set up by a client-side component in searching result pages: Internet users operate the browser (5001) to connect to search engine server (5006) in order to get the search result A client-side component is embedded in the search result page or web page. User setup communication link by operating mouse, keyboard, telephone or other information appliance to activate the said client-side component or operating the said component directly. Through script language, users operate the client-side component embedded in searching result pages (i) to set up link between control server and a client software or a call center or an information appliance through Internet(dashed line in FIG. 5); (ii) to set up link between control server and PSTN information appliance or a call center through gateway (real line in FIG. 5).

7. The Client-Side Component in Internet Web Pages.

Users operate client-side component by script language in web pages. This component set up communication by audio, video and data. By operating the component, user can call landline telephone directly from web page.

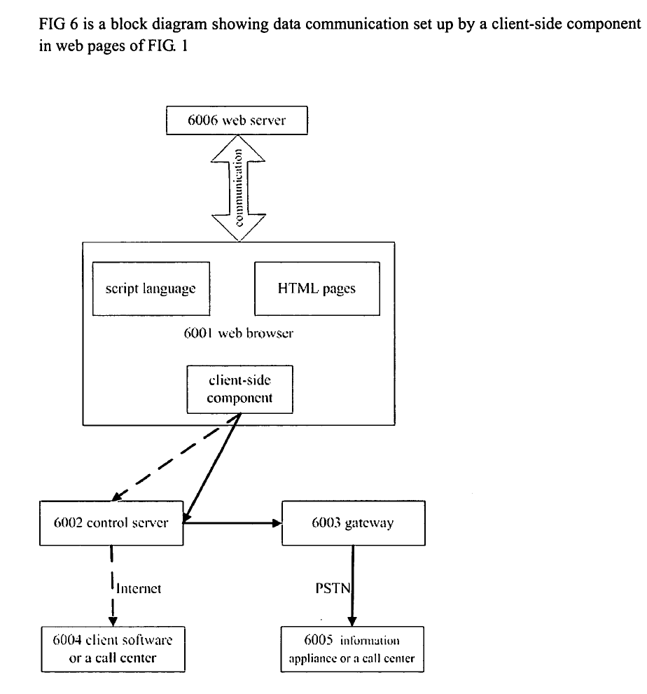

As shown in FIG. 6, data communication set up by a client-side component in web pages Internet user connects to web server (6006) by browser (6001). On HTML pages (6001), client-side component associates with client software or a call center or an information appliance, such as an ordinary telephone, PC or PDA. Users operate client-side component by script language in web pages (i) to set up link between control server (6002) and a client software or a call center or an information appliance (6004) (dashed line in FIG. 6); (ii) to set up link between control server (6002) and PSTN information appliance through gateway(6003) (real line in FIG. 6)

8. Function and Application of Client Software

The client software might run independently. Combined with information appliance, a group of client software constitutes a call center. Users can call into this call center directly through client-side component embedded in search engine or web-site.

9. Representation of Client-Side Component on the Internet Search Engine

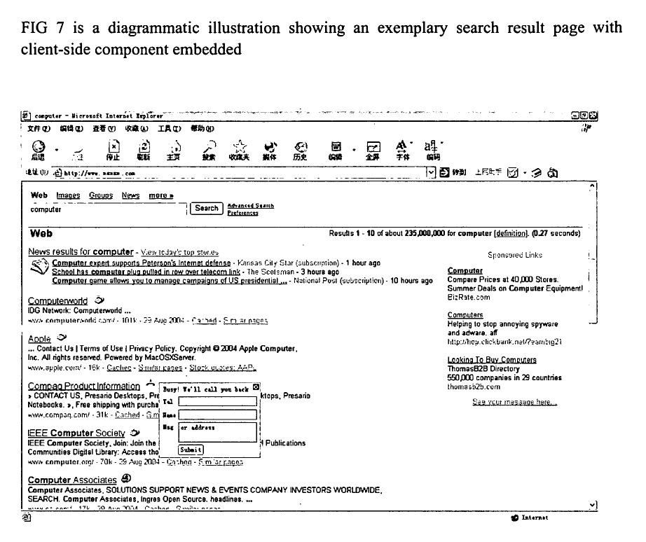

The said client-side component represents as web-page element such as a button, icon, picture, hyperlink or other visible objects. As shown in FIG. 7, searching result is followed by a button, which represents client-side component. The different appearance of button represents different state of a communication link These states include: available (ready for calling), unavailable (no service), connecting, ringing and busy. When a busy signal is reached, users are asked to input their telephone number, name, address and comment. The above information is stored in database for business query. Internet user can click on the button and follow the instruction to communicate with correspondent by audio, video, picture, file data, IVR data or the combination, or to communicate with information appliance directly.

10. Representation of Client-Side Component on Internet Web Page

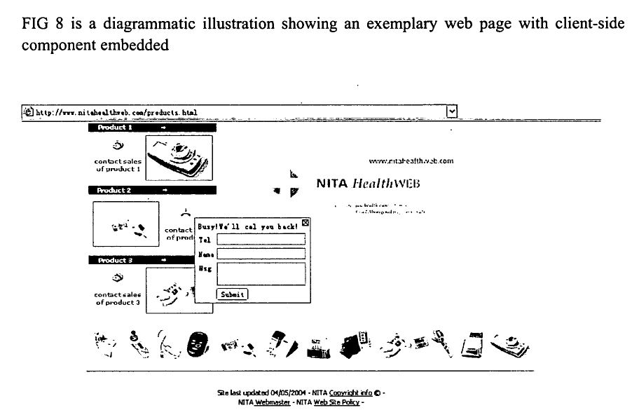

The said client-side component represents as web-page element such as a button, icon, picture, hyperlink or other visible objects. As shown in FIG. 8, the button representing client-side component on the web pages. Position and appearance of button might be different. The different appearance of button represents different state of a communication link These states include: available (ready for calling), unavailable (no service), connecting, ringing and busy. When a busy signal is reached, users are asked to input their telephone number, name, address and comment. The above information is stored in database for business query. Internet user can click on the button and follow the instruction to communicate with correspondent by audio, video, picture, file data, IVR data or the combination, or to communicate with information appliance directly.

11. Flow Chart of Client-Side Component Working with Search Engine

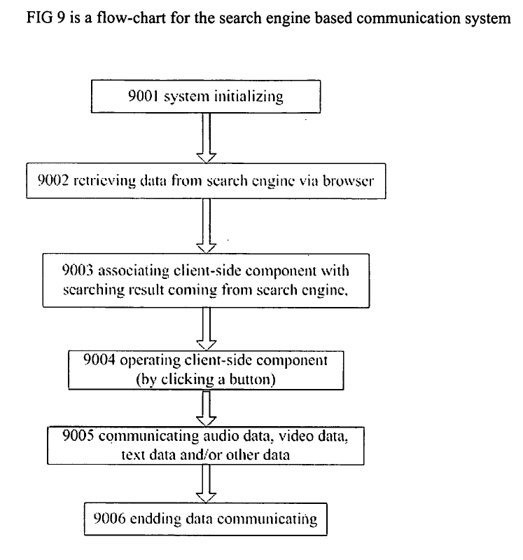

As shown in FIG. 9, system initializes (9001) first. Then Internet user search term or key word from search engine server or web browser (9002). Search engine provides searching result (9003). Client-side component associates with search result in step(9003). Internet user sets up communication link (9005) with client software or a call center or an information appliance by operating client-side component (9004). The communication channel closes.

12. Steps of Setting Up Communication Channel

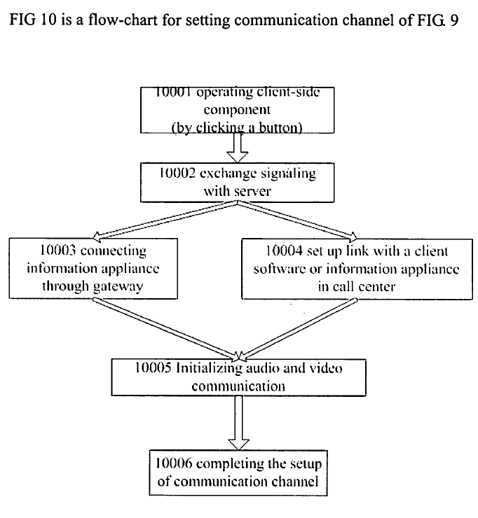

As shown in FIG. 10, user operates (for example by clicking a button) client-side component (10001). Client-side component exchange signaling (10002) with control server. According to different conditions, the control server can: (1) connect to information appliance (telephone, cell phone, PDA) (10003) in PSTN through gateway; (2) set up link with a client software (10004) or information appliance in call center. Initializing audio and video (10005) communication after link setup; completing the setup of communication channel (10006).

1. A method of calling and setting up communication link from a search engine and searching service, comprising: an information database storing merchant and customer information, said information including a name, a telephone number and an address; a search engine searching the database for particular data items in response to the input command and data; a client-side component or client setting up communication link with a business or organization or individual associating with the search result; an interface for search engine user inputting information into said database; a merchant interface for taking/answering the call from client-side component.

2. The method in claim 1, wherein to combine a communication function with search engine is to embed the client-side component into search result pages of search engine. User can set up communication link with a business or organization or individual, who associates with the search result, by operating a client-side component or client. The business or organization or individual may be identified using various means including their email address, their telephone numbers, or other unique identifier; denoted their ID, or some combination of these. Other means of identifying users are possible and the present invention is not limited to those listed here.

3. The method in claim 1, wherein to combine the communications function with Internet web-site by embedding the client-side component into the web page. By operating the client-side component from the said web page, user communicates with a business or organization or individual associating with the said web page.

4. The method in claim 1, wherein the said client-side component, embedded in the search result page or web page, represented as web-page element such as a button, icon, picture, hyperlink or other visible object, user setup communication link by operating mouse, keyboard, telephone or other information appliance to activate the said web-page elements or operating the said client-side component directly.

5. The method in claim 1, wherein the procedure of operating a client-side component is as follows:
a) System initialization;
b) Obtain the search result from search engine;
c) Display result in web browser, and show client-side component or its presentation, the web-page elements;
d) Set up communication link by operating the client-side component;
e) Data communication, the said data including voice, video, text, file and IVR output; and
f) Communication ended.

6. The method in claim 1, wherein the procedure of communication link setup by operating a client-side component is as follows:
a) Activate the client-side component by direct operation or indirect operation, for example: a click on web-page elements;
b) Signaling communicates between client-side component and control server;
c) Client-side component communicate with an information appliance, such as telephone, PC or PDA, or a call center through gateway; or Client-side component communicates with client software through a control server;
d) Audio/video appliance initialization: and
e) Communication link established.

7. The method in claim 1, wherein said information comprises a name, a telephone number associated with said name, and an address associated with said name.

8. The method in claim 1, wherein said merchant interface comprises a telephone handset, a client on PC or a PDA.

9. The method in claim 5, wherein said telephone handset comprises a mobile telephone.

10. A calling and communication system based on search engine and searching service comprising: (a)a database storing a plurality of data items; (b)a search engine searching the database for particular data items in response to the input command and data; (c)a control server for signaling control, communication management and fee schedule management; (d)a client-side component, embedded in search engine outputs, setting up signaling communication with control server, communicating data to gateway or client software and collecting user's information into the said database, said information including name, telephone number, address and message; (e)a web server hosting a web-site for a business or organization or individual who associates with the search result, the said client-side component also embedded in web pages of the said web-site; (f)a gateway transferring audio data into PSTN; and (g)a client software or (h)an interface or (i)a call center or (j)an information appliance, such as an ordinary telephone, PC or PDA, taking/answering the call.

11. The system in claim 10, wherein said system provides a communication platform. User starts communication by operating client-side component embedded in the search result coming from search engine. The said communication includes the one between Internet users, and the one between Internet user and PSTN user. Internet user communicates with other Internet user via client or client-side component embedded in web pages; Internet user can also communicate with PSTN user through control server, database server, gateway, telephone switcher. The telephone users can call the Internet user through the system too.

12. The system in claim 10, wherein said call center comprises telephone switcher, Internet access equipment, audio/video equipment, client software and client-side component. Internet users communicate by operating client software or client-side component embedded in web pages; Telephone users set up communicate by telephone.

13. The system in claim 10, wherein said system provides data communicating services, the said data including audio, video, text, picture, file, IVR output.

14. The system in claim 10, further comprising the external device, wherein said external device comprises a voice/speech input device.

15. The systems in claim 10, further comprising the external device, wherein said external device comprises a telephone.

16. The system in claim 10, further comprising the external device, wherein said external device comprises a device selected from the group consisting of a personal computer, notebook computer, personal data assistant (PDA), information appliance, or combination thereof.

17. The system in claim 10, wherein said communication link comprises the Internet.

18. The system in claim 10, wherein said data in (d) comprising voice, video, text, picture, file, IVR output and combinations thereof.

19. The system in claim 10, wherein said system provides audio coupons that operate as incentives for consumers to use the inventive system.

20. The system in claim 10, wherein said system provides benefits to merchants including but not limited to targeted reach, instant promotion, instant or near-term feedback, and an optional free Internet web presence.

21. The system in claim 10, wherein said system provides benefits to common carriers and telephone companies who process higher call volumes and attract new customers.

22. The system in claim 10, wherein said system provides the closest locations for a particular requested category where the location of the caller is known from a caller Internet IP address, a caller location input, cellular signal triangulation, GPS position determination, or other position or proximity location means.

23. The system in claim 10, wherein said system provides means for obtaining user contact information, by which once a caller gets connected to the business through the said system, after a period of time measured in hours the service calls back the caller to collect feedback, where the caller has either registered to permit this inquiry or does not have caller ID blocked.

24. The system in claim 10, wherein said system posts customer rating or testimonials so that future callers can hear/see these messages as a reference that may help make a choice of which merchant they want to be connected with, and optionally, as the service gets used callers can leave rating/testimonial messages which the business can choose to post for other users access.

25. The system in claim 10, wherein said system provides means for an over the telephone offer for a user to become an instant member to a community or coupon distribution list using email or other communications means once the user asks for a specific category.

26. The system in claim 10, wherein said system provides coupon targeting based on Internet IP address, area code and prefix, city, geographically coded location, GPS location, zip code, cross streets, vicinity of a milestone, major tourist areas, major landmarks, airports, and the like.

27. A business model for a business in which users call into a service by operating/activating a client-side component in the form of small plug-in software that is embedded in search engine result pages or web pages or browser, and the service provides responses to the request in speech and/or video data in real-time over the same client-side software or calls back to user if the said user registers their name and telephone number.

28. The business model in claim 24, further comprising calling-back features in which, when a busy signal is reached, users are asked to input their telephone number, name, address and comment, and the above information is stored in database for business query, which is for customer marketing and follow up purposes.

29. The business model in claim 24, further comprising partnership features in which the providing organization partners with a print yellow page or other business directory publisher and/or with direct marketing organizations to subscribe merchants, businesses, individual professionals, or other organizations.

30. The business model in claim 24, further comprising including organization partners selected from the set consisting of yellow page providers, wireless providers, telephone companies, and conventional 411 call centers, to partner and generate call traffic and thereby increase revenue.

31. The business model in claim 24, further comprising bringing a new business to direct marketing organizations through a channel of the system.

32. The business model in claim 24, wherein said method provides benefits to common carriers and telephone companies who save conventional 411 costs, process higher call volumes, and attract new customers.

33. The business model in claim 24, wherein said method provides benefits to search engine providers who sell the communication service to their client.

34. The business model in claim 24, wherein said method provides benefits to a business who place a client-side component on certain search results or on its own web pages to attract more customers.
